(19) United States
(12) Patent Application Publication
(10) Pub. No.: US 2012/0051835 A1
(43) Pub. Date: Mar. 1, 2012

(54) RELEASABLE SECURING DEVICE

(75) Inventors: Darel R. Taylor, Concord, OH (US); Harry P. Fuller, Newbury, OH (US); Tony Yagiela, Parma, OH (US)

(73) Assignee: JERGENS, INC., Cleveland, OH (US)

(21) Appl. No.: 13/222,219

(22) Filed: Aug. 31, 2011

Related U.S. Application Data
(60) Provisional application No. 61/379,003, filed on Sep. 1, 2010.
(60) Provisional application No. 61/485,344, filed on May 12, 2011.

(51) Int. Cl. F16B 21/00

(52) U.S. Cl. 403/322.2

(57) ABSTRACT

A spindle for a releasable securing device having a ball that cooperates with the spindle, which is located in a shank of the releasable securing device, is disclosed. The spindle includes a tapered land region and a ball pocket region. The tapered land region is configured to selectively contact the ball of the associated releasable securing device urging the ball outwardly in a radial opening formed in the shank of the associated releasable securing device. The land region includes an external surface tapering toward a central axis and a distal end of the spindle. The ball extends beyond an outer surface of the shank when contacted by the exterior surface. The ball pocket region is spaced from the tapered land region toward a proximal end of the spindle. The ball pocket region has a reduced diameter or size as compared to the tapered land region for allowing the ball to move inwardly into a ball pocket defined in the ball pocket region when the spindle is moved with respect to the shank of the associated releasable securing device such that the ball pocket region aligns with the radial opening in the shank of the associated releasable securing device

This application claims priority in U.S. Provisional Patent Application Ser. No. 61/379,003, filed on Sep. 1, 2010 and in U.S. Provisional Patent Application Ser. No. 61/485,344, filed May 12, 2011, both of which are incorporated by reference into this application.

### BACKGROUND

Hoist rings are useful to lift objects. A known hoist ring includes a lifting ring attached to a shank. The shank is inserted into a hole of the object that is to be lifted. A spindle, which is received within an axial opening of the shank, acts against balls located near a distal end of the shank. The balls are trapped in radial openings formed near a distal end of the shaft. The balls engage with the object to be lifted. With the balls engaging the object to be lifted, one connects a hoist line to the lifting ring to lift the object.

To release the hoist ring from the object that is to be lifted, one depresses a button, which is connected to the spindle, which aligns a ball pocket formed in the spindle with the radial openings in the shank. The balls fall into the ball pocket and the shank can be removed from the hole.

Known hoist rings are also designed to allow at least some rotational movement about the shank. However, it is believed that extreme rotation of the hoist ring could result in the spindle moving such that the ball pocket moves toward the balls, even when the button is not depressed. If this occurs, it could be undesirable.

### SUMMARY

A spindle that can overcome at least one of the aforementioned shortcomings is described in more detail below. The spindle is for a releasable securing device having a ball that cooperates with the spindle, which is located in a shank of the releasable securing device. The spindle includes a tapered land region and a ball pocket region. The tapered land region is configured to selectively contact the ball of the associated releasable securing device urging the ball outwardly in a radial opening formed in the shank of the associated releasable securing device. The land region includes an external surface tapering toward a central axis and a distal end of the spindle. The ball extends beyond an outer surface of the shank when contacted by the exterior surface of the land region. The ball pocket region is spaced from the tapered land region toward a proximal end of the spindle. The ball pocket region has a reduced diameter as compared to the tapered land region for allowing the ball to move inwardly into a ball pocket defined in the ball pocket region when the spindle is moved axially with respect to the shank of the associated releasable securing device such that the ball pocket region aligns with the radial opening in the shank of the associated releasable securing device.

A lifting pin that can overcome at least one of the aforementioned shortcomings includes a shank, a ball, a spindle, a release mechanism and a biasing member. The shank includes an axial passage extending along a longitudinal axis and a radial opening extending from the axial passage to an outer surface of the shank. The ball is received in the radial opening of the shank and is movable in a radial direction in the radial opening between a first position where a portion of the ball extends radially outward from the radial opening beyond the outer surface of the shank and a second position where the ball is offset radially inwardly or substantially flush with the outer surface of the shank. The spindle is received in the axial passage and is movable with respect to the shank in a first axial direction and a second axial direction, which is opposite the first axial direction. The spindle includes a proximal end connected with the release mechanism, a distal end opposite the proximal end, a tapered land region, and a ball pocket region. The tapered land region acts against the ball to inhibit radial inward movement of the ball in the radial opening when the tapered land region is aligned with the radial opening. The ball pocket region is reduced in size as compared to the tapered land region, which allows the ball to move inwardly into a ball pocket when the ball pocket region is aligned with the radial opening. The tapered land region defines a generally conical exterior surface tapering inwardly toward the longitudinal axis and the distal end of the spindle. The biasing member acts against the spindle to bias the spindle in the second axial direction such that the conical exterior surface of the tapered land region contacts the ball urging the ball radially outward in the radial opening.

Another example of a lifting pin includes a shank, a ball, a spindle, a release mechanism and a biasing member. The shank includes an axial passage extending along a longitudinal axis and a radial opening extending from the axial passage to an outer surface of the shank. The ball is received in the radial opening of the shank and is movable in a radial direction in the radial opening between a first position where a portion of the ball extends radially outward from the radial opening beyond the outer surface of the shank and a second position where the ball is offset radially inwardly or generally flush with the outer surface of the shank. The spindle is received in the axial passage and is movable with respect to the shank in a first axial direction and a second axial direction, which is opposite the first axial direction. The spindle includes a distal end, a proximal end opposite the distal end, a land region, and a ball pocket region. The land region acts against the ball to inhibit radial inward movement of the ball in the radial opening toward the longitudinal axis when the land region is aligned with the radial opening. The ball pocket region has a reduced diameter or size as compared to the land region which allows the ball to move inwardly into a ball pocket when the ball pocket region is aligned with the radial opening. The land region defines an exterior surface that exerts a force on the ball made up of a first vector that is perpendicular to the longitudinal axis and a second vector that is parallel to the longitudinal axis and is in a direction toward the distal end of the spindle. The biasing member acts against the spindle to bias the spindle in the second axial direction such that the exterior surface of the land region contacts the ball urging the ball radially outward in the radial passage.

### BRIEF DESCRIPTION OF THE DRAWINGS

FIG. 1 is a schematic cross-sectional view of a releasable securing device, such as a lifting pin.

FIG. 2 is a schematic depiction of the circled portion of FIG. 1.

FIG. 3 is a schematic depiction of an alternative embodiment of a distal end of a spindle and a shank for a releasable securing device.

FIG. 4 is a cross-sectional view of a lifting pin.

FIG. 5 is another cross-sectional view of the lifting pin shown in FIG. 4.

FIG. 6 is a cross-sectional view of a distal end of the lifting pin shown in FIG. 4.

FIG. 7 is another cross-sectional view of the lifting pin shown in FIG. 4.

### DETAILED DESCRIPTION

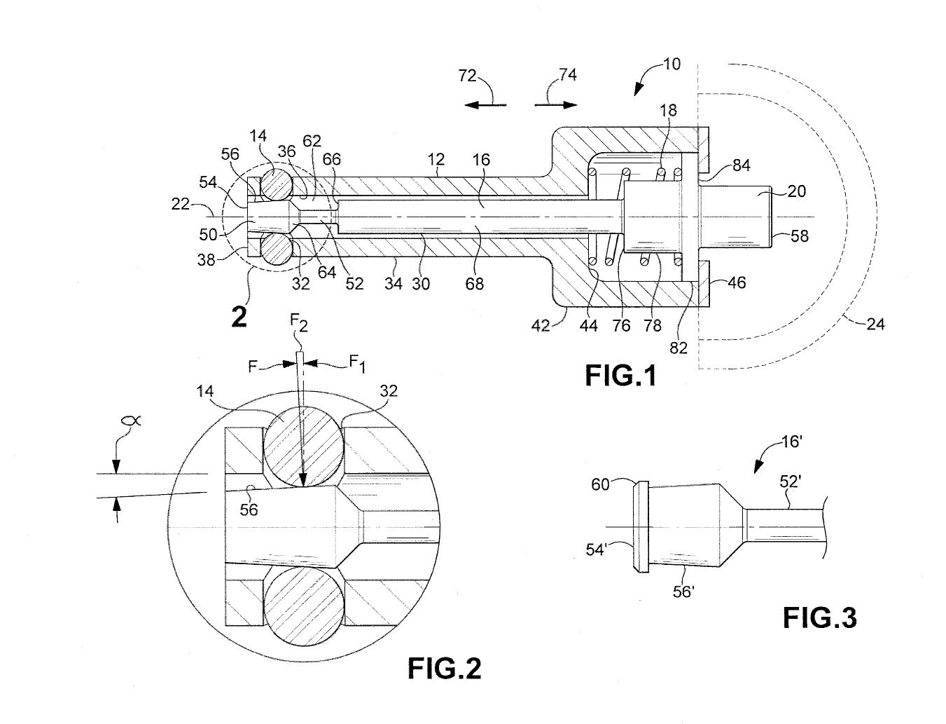

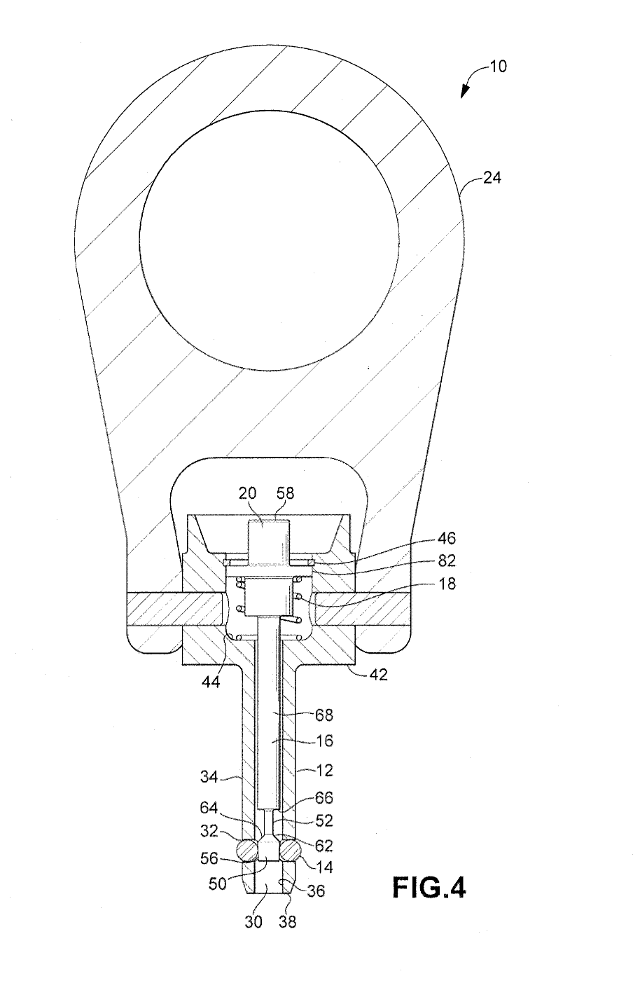

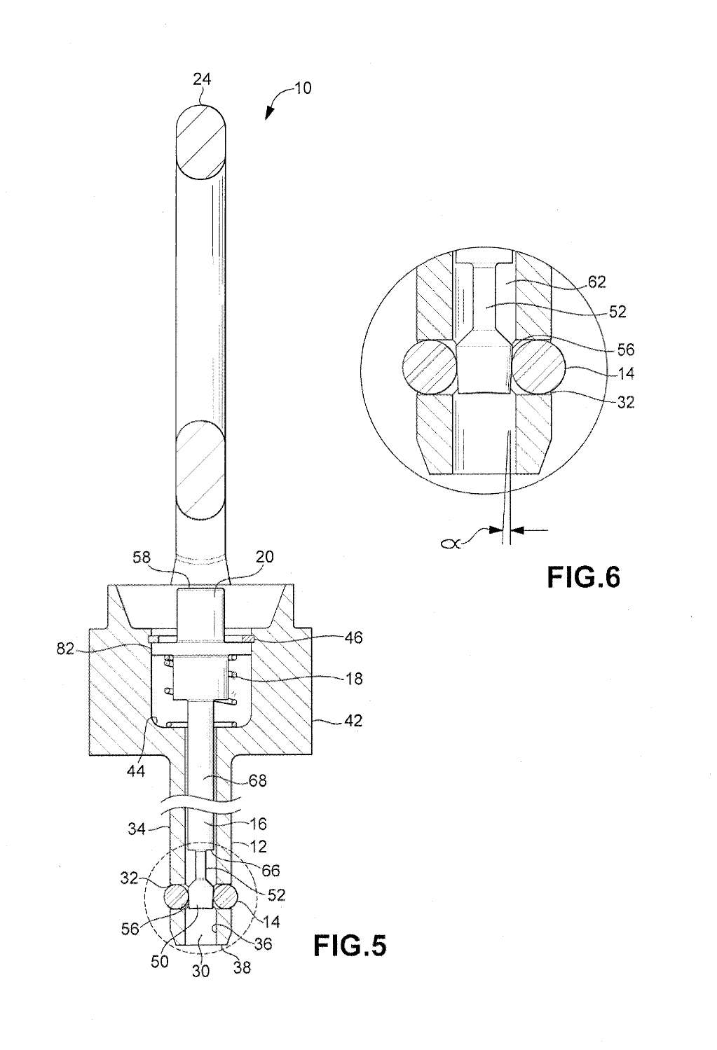

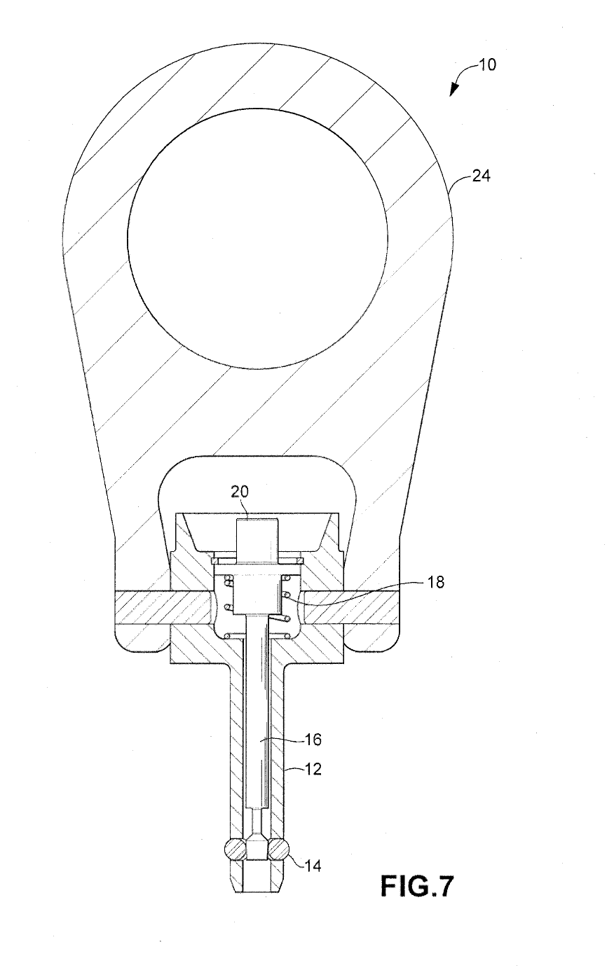

FIGS. 1, 4, 5, 6 and 7 depict a releasable securing device 10, which can include ground handling pins, ball pins, hoist rings and lifting pins. The releasable securing device 10 includes a shank 12, at least one ball 14 (a plurality balls are depicted), a spindle 16, a biasing member 18, and a release mechanism 20, such as a button. The releasable securing device 10 is useful for a wide range of uses including, but not limited to lifting an item, similar to the hoist ring described above, by inserting the shank 12 into an opening or bore (not shown) where the balls 14 engage the item to be lifted (not shown). The releasable securing device 10 is also useful in securing two items together, similar to known handling pins. The releasable securing device can include a lifting ring 24, which is depicted schematically in FIG. 1 as connected with the shank 12, which can also rotate and/or swivel.

The shank 12 includes an axial opening 30 extending along the longitudinal axis 22 and a radial opening 32 (a plurality of radial openings are depicted) extending from the axial passage 30 to an outer surface 34 of the shank. In the illustrated embodiment, the axial passage 30 is circular in a cross-section taken normal to the longitudinal axis 22 and defines an interior shank surface 36. The shank 12 in the illustrated embodiment is made of a hard material, such as metal, but could be made from other hard materials and/or included hardened portions. The shank 12 is generally cylindrical in configuration and is coaxial with the longitudinal axis 22. The axial passage 30 is also coaxial with the longitudinal axis 22. The shank 12 includes a distal end 38 with respect to release mechanism 20. The axial passage 30 opens at the distal end 38. Each radial opening 32 can be swaged to prevent the balls 14 from escaping from the shank 12 when acted upon by the spindle 16.

In the illustrated embodiment, the shank 12 includes an enlarged housing section 42 in which the biasing member 18 is housed but this is not required. The housing section 42 can be integrally formed with the remainder of the shank 12 and cylindrical in configuration. Alternatively, the shank 12 can connect with the housing section 42 and/or a flange. In the illustrated embodiment, the housing section 42 is hollow and also coaxial with the longitudinal axis 22. The housing section 42 defines an annular shoulder 44 against which the biasing member 18 acts to bias the spindle 16 in a manner that will be described in more detail below. A cap 46, or similar retaining member (e.g., snap ring) connects with the housing section 42 in a conventional manner to maintain the spindle 16 within the shank 12 and the housing section 42. However, any pin arrangement could be used without departing from the invention of this application where the depicted pin is only an example and should not be construed as limiting.

The balls 14 are received in the shank 12 and are movable in a radial direction with respect to the longitudinal axis 22 in each radial opening 32. Each ball 14 is movable between a first position where a portion of each ball extends radially outward from the respective radial opening 32 beyond the outer surface 34 of the shank 12 (shown in FIG. 1) and a second position (not shown, but similar to known lifting pins) where the ball is offset radially inwardly or generally flush with the outer surface of the shank. Each ball 14 in the depicted embodiment can be spherical in shape and made from a hardened material, such as metal or the like. Each ball can be made from another hard material, if desired.

The spindle 16 can also be made from a hard and/or hardened material, e.g. metal or heat treated metal. The spindle 16 includes a tapered land region 50 and a ball pocket region 52. The tapered land region 50 is configured to selectively contact each ball 14 urging the respective balls towards a respective radial opening 32 formed in the shank 12. The land region 50 tapers toward the longitudinal axis 22, which can also be referred to as a central axis, and a distal end 54, with respect to the release mechanism 20 of the spindle 16. The tapered land region 50 in the illustrated embodiment includes a conical external surface 56 having a taper angle α, which is defined between the external surface 56 and a line intersecting the external surface and parallel to the longitudinal axis (or central axis) 22. The taper angle α can be less than 10 degrees. More particularly, the taper angle α can be less than 5 degrees. Even more particularly, the taper angle α can be between about 2.0 degrees and about 4.0 degrees. In one embodiment, the taper angle α is approximately 3.0 degrees.

The ball pocket region 52 is spaced from the tapered land region 50 toward a proximal end 58 of the spindle 16. As illustrated, the ball pocket region 52 has a reduced diameter or size as compared to the tapered land region 50. This allows the ball 14 to move inwardly into a ball pocket 62 defined in the ball pocket region 52 when the spindle 16 is moved against the biasing force of the biasing member 18 with respect to the shank 12 such that at least a portion of the ball pocket region 52 aligns with each radial opening 32 in the shank 12 of the releasable securing device 10. When at least a portion of the ball pocket region 52 aligns with each radial opening 32, each ball 14 can move into the ball pocket 62 and occupies the second position where the ball 14 is offset radially inwardly or generally flush with the outer surface 34 of the shank 12.

The spindle 16 also includes a tapered transitional region 64 where the spindle 16 transitions from the tapered land region 50 into the reduced diameter section of the ball pocket region 52. In the illustrated embodiment, the tapered land region 50 has its greatest diameter at the conjunction of the tapered land region with the tapered transitional region 64. The tapered land region 50 tapers from this greatest diameter toward the distal end 54 and the longitudinal (central) axis 22.

The spindle 16 can also includes a first radial shoulder 66 at the transition between the reduced diameter section of the ball pocket region 52 and an intermediate shaft region 68. The ball pocket 62 is defined generally between the tapered transitional region 64 and the first radial shoulder 66. The diameter of the spindle 16 at the intermediate shaft region 68 and the diameter of the spindle 16 at the greatest diameter of the tapered land region 50 can be nearly equal to each other. Moreover, the diameter of the spindle 16 at the intermediate shaft region 68 and/or the diameter of the spindle 16 at the greatest diameter of the tapered land region 50 can be slightly smaller than the internal diameter of the shank 12, which is defined by the internal surface 36. The spindle 16 is received in the axial passage 30 and is movable with respect to the shank 12 in a first axial direction 72, which is a releasing direction, and in a second axial direction 74, which is opposite the first axial direction, due to the biasing force of the biasing member 18.

The spindle 16 can also include a second radial shoulder 76 that transitions from the intermediate shaft 68 into an enlarged internal region 78. The spindle 16 can also include a flange 82, which is generally annular in configuration. As illustrated, the release mechanism 20 extends from the annular flange 82 through an opening 84 in the cap 46 toward the proximal end 58 to define a button. Note, however, that the release mechanism can be one or more separate components joined to the spindle 16. The entire spindle 16, which includes the tapered land region 50, the tapered transitional region 64, the ball pocket region 52, the first annular shoulder 66, the intermediate shaft region 68, the annular shoulder 76, the enlarged internal region 78, the flange 82, and the release mechanism 20 (which is depicted as a button) are in the shown embodiment, cylindrical, and therefore circular in a cross section taken normal to the longitudinal axis 22. The spindle 16 can take alternative configurations.

The conical exterior surface 56 of the spindle 16 can extend from the distal end 54 of the spindle to the ball pocket region 52, which is shown in FIGS. 1 and 2. This configuration is opposed to simply being a conical tip or chamfer found in known spindles for assembly purposes where the conical tip or chamfer allows the known spindle to be more easily inserted into the axial passage 30. An alternative spindle arrangement is shown in FIG. 3, where the spindle 16′ includes the conical exterior surface 56′ where the conical exterior surface does not extend all the toward the distal end 54′ from the ball pocket region 52′. Moreover, the spindle 16′ (as well as the spindle 16) can also include a chamfer 60 (a chamfer is not shown in FIG. 1 even though the spindle could include such a chamfer).

With reference to FIG. 2, the land region 50 (FIG. 1) defines the exterior surface 56. When the releasable securing device 10 (FIG. 1) is in the locked condition (when the balls 14 are in the second position extending radially outward from the respective radial opening 32 beyond the outer surface 34 of the shank 12) the ball 14 exerts a force F on the exterior surface 56 in a direction normal to the exterior surface 56. This force F on the exterior surface 56 is made up of a first vector F₁ that is perpendicular to the longitudinal axis 22 (FIG. 1) and a second vector F₂ that is parallel to the longitudinal axis and is in a direction away from the distal end 54 of the spindle.

The biasing member 18 acts against the spindle 16 to bias the spindle in the second axial direction 74 such that the exterior surface 56 of the land region 50 contacts the ball(s) 14 urging each radially outward in the respective radial passage 32. In the illustrated embodiment, the biasing member 18, which can be a conventional coil spring, acts against the radial shoulder 44 formed in the housing section 42 and against the flange 82 of the spindle 16 to bias the spindle 16 in the second axial direction 74. The biasing member 18 can be located elsewhere in the releasable securing device 10, e.g. acting against the radial shoulder 44 and the second radial shoulder 76 of the spindle 16 where any releasable securing device configuration could be used with the invention of this application. When the spindle 16 is biased in the second axial direction 74, the conical exterior surface 56 of the tapered land region 50 contacts the ball 14 when the tapered land region 50 is aligned with the radial opening 32 urging the ball radially outwardly in the radial opening 32. As discussed above, the force F has a vector F₂ parallel with the longitudinal axis 22. This parallel vector F₂ has a direction that is the same as the second axial direction 74, i.e. the force F₂ being imparted on the ball 14 in a direction parallel to the longitudinal axis 22 is in the same direction to the biasing force of the biasing member 18.

By providing the tapered land region 50 having the exterior surface at a tapered angle α, when the releasable securing device 10 is put into a bore (the bore is not shown in FIG. 2 for clarity purposes) and in the locked condition, a force in a direction parallel to the longitudinal (central) axis 22, i.e. force F₂ in FIG. 2, is being imparted by the ball 14 on the exterior surface 56 in the same direction that the biasing member 18 is biasing the spindle 16, as depicted by arrow 74 in FIG. 1. This precludes or inhibits unintended movement of the spindle 16 in the releasing direction 72. Accordingly, unintended movement of the ball pocket region 52 toward the ball 14 (i.e. in the second direction 74) without depressing the release mechanism 20 is inhibited.

A spindle for a releasable securing device and a releasable securing device including such a spindle has been described with particularity with respect to the depicted embodiment. Modifications and alterations will occur to those upon reading and understanding the preceding detailed description. The invention, however, is not limited to only the embodiment described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A spindle for an associated releasable securing device having a ball that cooperates with the spindle located in a shank of the associated releasable securing device, the spindle including:
a tapered land region configured to selectively contact the associated ball of the associated releasable securing device urging the ball toward a radial opening formed in the shank of the associated releasable securing device, the land region tapering toward a central axis and a distal end of the spindle and the ball extends beyond an outer surface of the shank when contacted by the tapered land region; and
a ball pocket region spaced from the tapered land region toward a proximal end of the spindle, wherein the ball pocket region has a reduced size as compared to the tapered land region for allowing the ball to move inwardly into a ball pocket defined in the ball pocket region when the spindle is moved with respect to the shank of the associated releasable securing device such that the ball pocket region at least partially aligns with the radial opening in the shank of the associated releasable securing device.

2. The spindle of claim 1, wherein the tapered land region is conical having a taper angle, which is defined between the tapered land region and a line intersecting the tapered land region and parallel to the central axis, of less than 10 degrees.

3. The spindle of claim 2, wherein the taper angle is less than 5 degrees.

4. The spindle of claim 3, wherein the taper angle is between about 2.0 and about 4.0 degrees.

5. The spindle of claim 4, wherein the taper angle is approximately 3 degrees.

6. The spindle of claim 1, wherein the spindle moves in a releasing direction, which is parallel to the central axis, to at least partially align the ball pocket region with the radial opening, and the tapered land region is configured such that a force being applied on the tapered land region by the associated ball has a vector parallel with and in an opposite direction as the releasing direction.

7. A releasable securing device comprising:
a shank including an axial passage extending along a longitudinal axis and a radial opening extending from the axial passage to an outer surface of the shank;
a ball received in the shank and movable in a radial direction in the radial opening between a first position where a portion of the ball extends radially outward from the radial opening beyond the outer surface of the shank and a second position where the ball is offset radially inwardly or generally flush with the outer surface of the shank;
a release mechanism;
a spindle received in the axial passage and movable with respect to the shank in a first axial direction and a second axial direction, which is opposite the first axial direction, the spindle including a proximal end connected with the release mechanism, a distal end opposite the proximal end, a land region that acts against the ball to inhibit radial inward movement of the ball in the radial opening when the land region is aligned with the radial opening and a ball pocket region having a reduced size as compared to the tapered land region which allows the ball to move radially inwardly into a ball pocket as the ball pocket region moves into alignment with the radial opening, the land region, including an inwardly tapered exterior surface tapering inwardly toward the longitudinal axis and the distal end of the spindle, the exterior surface engaging the ball when in the first position; and
a biasing member acting against the spindle to bias the spindle in the second axial direction such that the exterior surface of the tapered land region contacts the ball urging the ball radially outward in the radial passage.

8. The device of claim 7, wherein the release mechanism includes a button joined to the spindle.

9. The device of claim 7, wherein the exterior surface generally extends between the distal end of the spindle to the ball pocket region.

10. The device of claim 7, wherein the ball imparts a force on the exterior surface when the tapered land region is aligned with the radial opening, wherein the force includes a parallel vector that is parallel with the longitudinal axis.

11. The device of claim 9, wherein the parallel vector has a direction that is the same as the second axial direction.

12. The device of claim 11, wherein the force further includes a perpendicular vector that is perpendicular to the longitudinal axis.

13. The device of claim 7, wherein exterior surface has a taper angle, which is defined between the external surface and a line intersecting the external surface and parallel to the central axis, of less than 5 degrees.

14. The device of claim 13, wherein the taper angle is between about 2.0 and about 4.0 degrees.

15. The device of claim 7, further including a lifting ring joined to the shank.

16. A quick release pin comprising:
a shank including an axial passage extending along a longitudinal axis and a radial opening extending from the axial passage to an outer surface of the shank;
a ball received in the shank and movable in a radial direction in the radial opening between a first position where a portion of the ball extends radially outward from the radial opening beyond the outer surface of the shank and a second position where the ball is offset radially inwardly or generally flush with the outer surface of the shank;
a release mechanism;
a spindle received in the axial passage and movable with respect to the shank in a first axial direction and a second axial direction, which is opposite the first axial direction, the spindle including a proximal end connected with the release mechanism, a distal end opposite the proximal end, a land region that acts against the ball to inhibit radial inward movement of the ball in the radial opening toward the longitudinal axis when the land region is aligned with the radial opening and a ball pocket region having a reduced size as compared to the land region which allows the ball to move inwardly into a ball pocket when the ball pocket region moves into alignment with the radial opening, the land region having an exterior surface such that the ball exerts a force on the exterior surface made up of a first vector that is perpendicular to the longitudinal axis and a second vector that is parallel to the longitudinal axis and is in a direction away from the distal end of the spindle; and
a biasing member acting against the spindle to bias the spindle in the second axial direction such that the exterior surface of the land region contacts the ball urging the ball radially outward in the radial opening.

17. The pin of claim 16, wherein the external surface is conical having a taper angle, which is defined between the external surface and a line intersecting the external surface and parallel to the central axis, of less than 10 degrees.

18. The pin of claim 17, wherein the taper angle is less than 5 degrees.

19. The pin of claim 18, wherein the taper angle is between about 2.0 and about 4.0 degrees.

20. The pin of claim 16, further comprising a lifting ring joined to the shank.

21. The pin of claim 16, wherein the spindle includes a chamfer at the distal end.
